(19) United States
(12) Patent Application Publication
(10) Pub. No.: US 2010/0108333 A1
(43) Pub. Date: May 6, 2010

(54) FIRE EXTINGUISHER WITH DISPOSABLE PLASTIC CONTAINER

(76) Inventor: Augusto de Jesus Delgado, JR., Goiania (BR)

Correspondence Address: FURR LAW FIRM, 2622 DEBOLT ROAD, UTICA, OH, 43080, US

(21) Appl. No.: 12/593,876

(22) PCT Filed: Mar. 28, 2008
(86) PCT No.: PCT/BR08/00114

§ 371 Date: Sep. 29, 2009

(30) Foreign Application Priority Data
Mar. 29, 2007 (BR) PI 0702725-7

(51) Int. Cl. A62C 13/62

(52) U.S. Cl. 169/71

(57) ABSTRACT

Fire extinguisher with disposable plastic container refers to a disposable fire extinguisher that works with direct pressure (internal) in a Container (01) manufactured with high viscosity Polyamide, Fiberglass and mineral elements composed by calcium, aluminum, magnesium, phosphorus, sodium, titanium, iron, potassium, zinc, strontium, copper, manganese and chrome, besides others for U.V protection., with a five millimeters thick Wall (P) and cylindrical shape extremities with an 180° Angle (G) ray, and Ribs (N) from plastic concentration at the welded areas.

Refers the present invention to a Fire Extinguisher manufactured with an internal plastic Container from an engineering combination process and composite of a high viscosity Polyamide, Fiberglass and minerals, with mechanical resistance characteristics similar to steel, able to support the internal pressure and external impacts.

There was found the patent EP-0283568 and the American patent U.S. Pat. No. 4,854,343, and they both refer to fire extinguishers, and it was possible also verify that these two patents glimpsed the possibility to manufacture such extinguishers in metallic material and/or plastics, however, it is known that until then it was not possible the development of a plastic Container capable to support the internal pressure caused by the components such as the chemical powder among others or pressures caused by external impacts.

In the American patent U.S. Pat. No. 4,854,343 can be noticed that the used physical shape of the Container (cylindrical tube) has a minimum angle for the rounded corners on the inferior and superior parts, according to the illustrations 1 and 4 of the referred patent. This fact allied to the lack of a plastic to support high pressures, contributed in a way it was not possible the production of a fire extinguisher in plastic material but only in metal as steel carbon or aluminum, so that the Container of cylindrical shape presented and the lack of an appropriate plastic (polymer), frustrated the manufacture of fire extinguishers with plastic Container.

As to the patent EP-0283568, it presented a constructive disposition that would make possible the production of fire extinguishers in plastic material, by the fact this patent foresees that inside of the Receptacle (1) there would be a Bottle-flask (11) so that the necessary pressure to expel the fire extinguishing product, would not be inside the plastic Receptacle (1), but in the bottle-flask (11) with the purpose to blow out the said fire extinguishing product, what would be a very complex fire extinguisher in terms of production and assembly, besides being very expensive due to the great number of components and the purpose of the plastic Receptacle (1), would be pure and simply to store the extinguishing product and not to support the direct pressure as it is the case of regular fire extinguishers, as well as the extinguisher that is object of this present invention, in other words, the object of the patent EP-0283568 glimpsed the possibility to manufacture extinguishers of plastic using a system of indirect pressurization, commonly used in steel extinguishers.

As described, the two systems didn't prosper with this sort of plastic Container due to the presented difficulties, but this present invention innovates building a plastic Container manufactured with of high viscosity Polyamide, Fiberglass and minerals, of cylindrical shape, differentiated from the existing extinguishers found in the state of technique, in the sense that the Container could support besides a variable thermal resistance, also great loads of internal pressure and external aggressions, also with the advantage of being the plastic many times lighter than steel, making this Fire Extinguisher a lot lighter than the conventional ones made of steel, being such Container susceptible to recycling for the production of new ones avoiding aggressions to the environment, contributing for the partner-environmental echo-efficiency. With the purpose of solving such inconveniences and difficulties the present invention was developed also with colored plastic pigmentation that will facilitate color variations in agreement to the consumer's need and to technical standards, although the plastic Container presented here is in red, due to the effective safety standards. The referred plastic Container has chemical and mechanical resistance superior to those of steel with the benefit of not being corrosive and susceptive to rust, or plastic alterations in behavior, supporting exposition to chemical products or others and resistant to ultra-violet light (U.V), maintaining the color stability on the extinguisher, and the present invention will be better understood in consonance with the annex illustrations where:

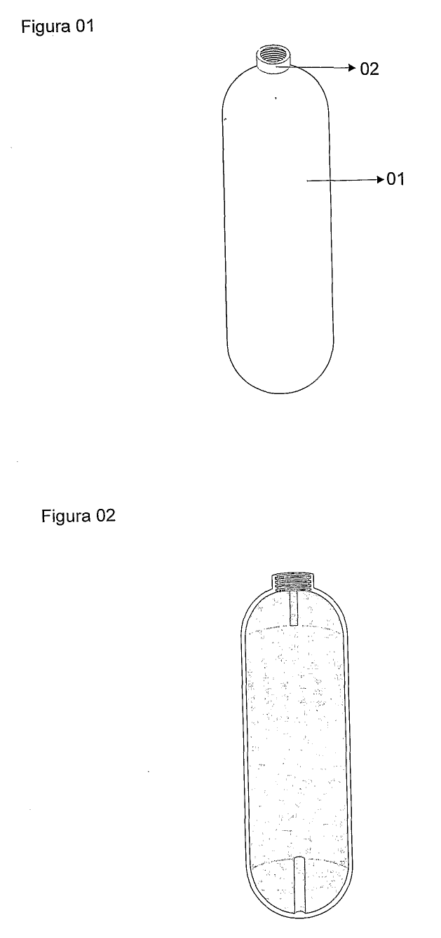

The FIG. 1 displays a perspective view of the plastic Container of the present invention.

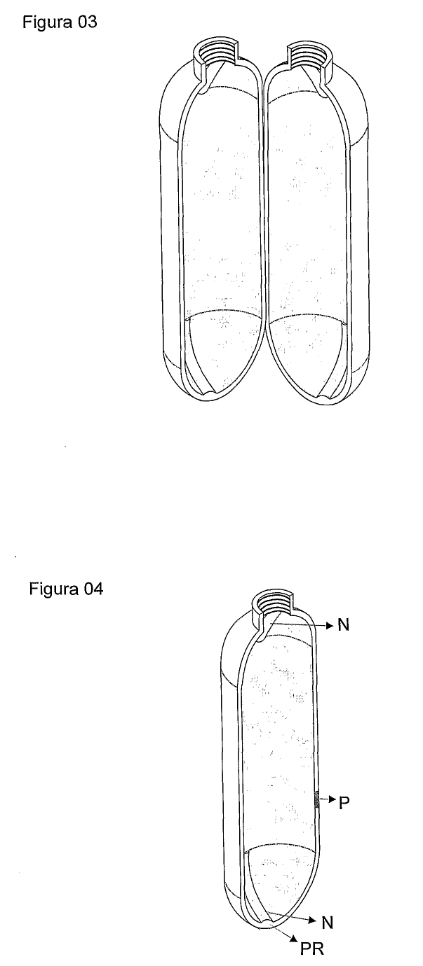

The FIG. 2 displays an up strait cut of the plastic Container making possible an internal visualization.

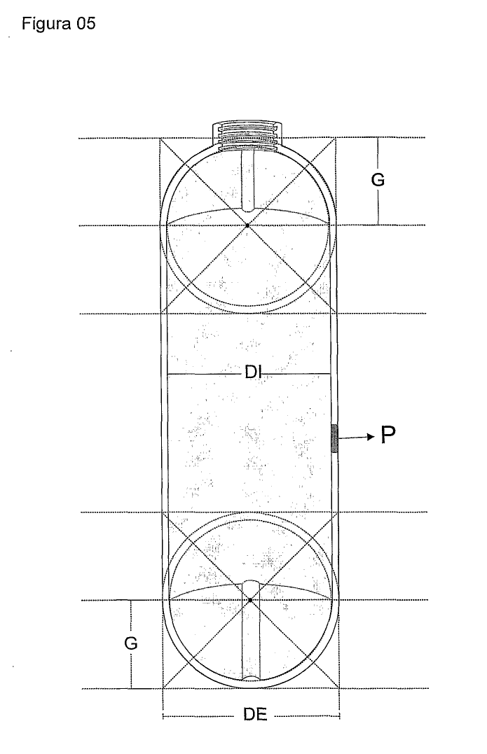

The FIG. 3 displays a sidelong cut of the plastic Container in two halves.

The FIG. 4 displays in perspective a straight cut of the plastic Container.

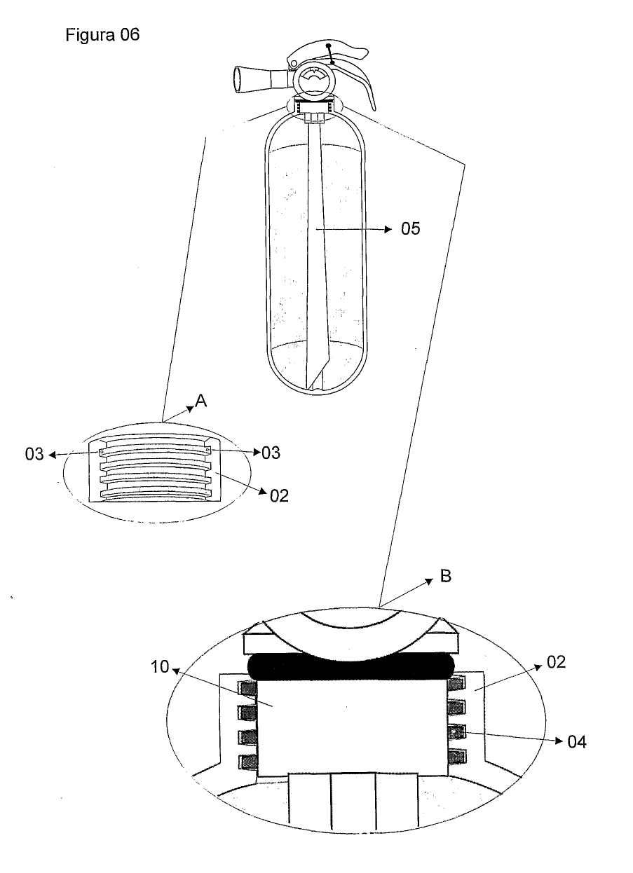

The FIG. 5 displays the same view of Illustration 2 however with schematic details of the round shape applied to the extremities of the plastic Container.

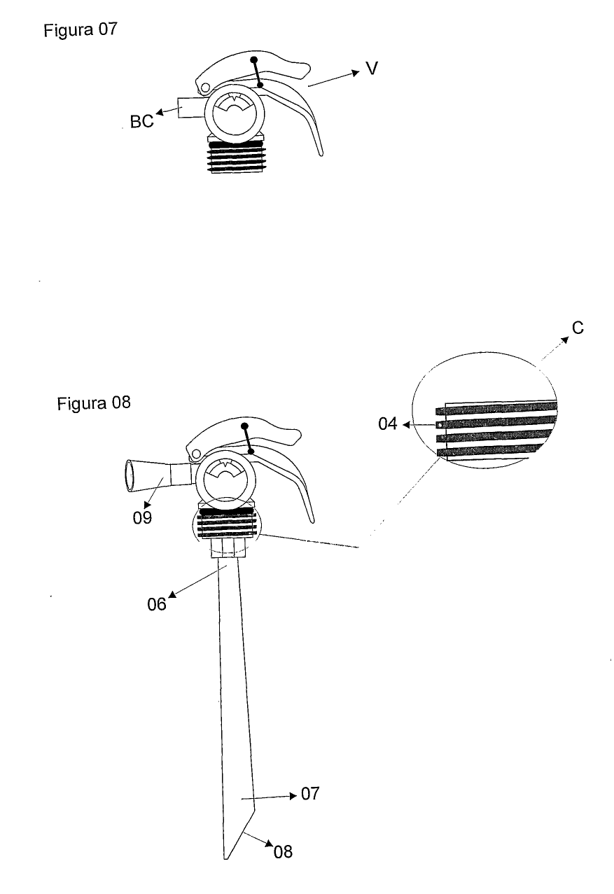

The FIG. 6 displays the assembled Fire Extinguisher with the action Valve, and a straight cut of the plastic Container, besides two details (A and B) enlarged for a better understanding.

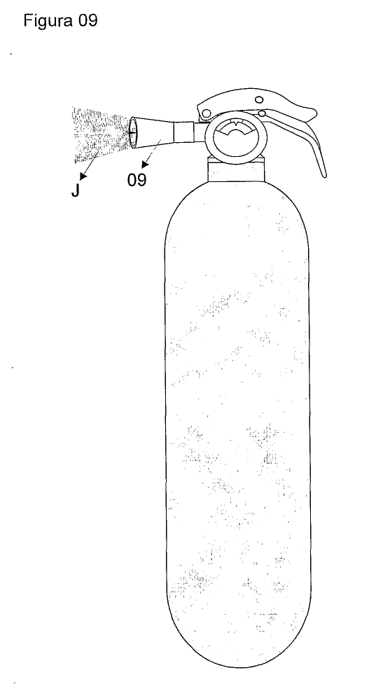

The FIG. 7 displays a front view of the action Valve traditionally used in regular fire extinguishers.

The FIG. 8 displays the transport group of the fire extinguishing product, showing an enlarged detail (C) of the external Thread. The Illustration 9 shows the Fire Extinguisher properly mounted and simulation of action.

As can be seen on the Illustrations, there is a plastic Container (01) with a Mouthpiece (02) with internal Threads (03) to receive external Threads (04) located at the base (10) of the Valve (V); and also a conductive Tube (05) outlet for the fire extinguishing content.

To build a Fire Extinguisher manufactured with a plastic Container was necessary to ally the plastic production technology to provide the supporting resistance, besides the internal pressure (once the international standards dictates that the pressure should be enough to expel the whole content of the fire extinguishing product in a determined time) and external aggressions (so the fire Extinguisher doesn't break with impacts with occasional external aggressions, eliminating injure risks by users) to a specific cylindrical shape with maximum reduction of the internal mechanical resistance caused by the straight and semi-straight corners (sharp corners).

Thus, by the use of a raw material technologically denominated Engineering Polymer, of high viscosity Polyamide, Fiberglass and traces of the following minerals: silicon, calcium, aluminum, magnesium, phosphorus, sodium, titanium, iron, potassium, zinc, strontium, copper, manganese and chrome, as well as pigments for the definition of the color, besides supplements for U.V protection, to associate mechanical, thermal resistance being able to resist temperatures, thus solving the plastic resistance problem through the creation of this Engineering Polymer.

Besides a suitable Plastic was still necessary to manufacture a plastic Container (01) with a Wall (P) capable to offer enough resistance to support the internal pressure and external aggressions, so this wall (P) was manufactured with thickness between three and twenty millimeters, with better economical and resistance results with five millimeters for the model P1 extinguisher for small family vehicles. The same way it was also important to have it built in a cylindrical shape to reduce to maximum the internal mechanical resistance, usually caused by sharp corners, and it was solved by manufacturing the said plastic Container (01) with both extremities in total cylindrical shape, where independently of the external Diameter (DE) and internal Diameter (DI) the extremities will have an 180° Angle (G) ray, eliminating rupture risks in these ends that are usually critic.

In the plastic Container process of production of the present invention, it was necessary besides overcoming the difficulties mentioned above, there was also the need to have enough welding resistance on the region between the cut made by the mold head on each, inferior (bottom) and superior (Mouthpiece), cylindrical extremities. For that, it was necessary to provide means to weld the extremities of the plastic container in a way that where the wall was cut, it was welded through the union of one wall to the other, causing a fusion with a little excess of plastic in that local in a way the plastic Container wall becomes thicker in that spot, forming a small Rib (N) on both inferior and superior parts, with plastic concentration in this rib of something between ten and a hundred percent of the thickness of the Wall (P) being twenty percent the ideal, although tests have proved that it could have the same thickness of the said Wall (P), and this procedure eliminates the difficulty to provide resistance on junctions of the plastic Container cut (01).

Another problem to be solved for the Extinguisher to become viable was that, being the Container (01) and the Valve (V) made of plastic, there was a possibility that the said Container (01) could be reutilized and recharged by companies without any commitment with quality and safety (the reutilization and recharge is not allowed by the effective norms), offering the risk of having the Valve (V) unscrewing with little effort while the extinguisher is still pressurized, and to prevent that, the innovation of present claim is the that the external Thread (04) of the Valve (V) is welded to the internal Thread (03) of the Mouthpiece (02) through a process of molecular fusion by laser welding, making of them a single unit. This procedure makes impracticable any reutilization attempt as much of the Valve (V) as of the plastic Container (01) making of them disposable parts, that could only be recycled, ensuring that they would not be reused following the vehicles fire extinguishers regulation norms.

As described, only the high resistance of the plastic polymer would not be enough to make possible the manufacturing of a fire extinguisher with internal plastic Container using the same cylindrical configurations presented in extinguishers found in the state of technique and the same direct pressure system, in other words, the pressure inside the Container without using a Bottle flask with indirect pressurization.

For a practical use of the present plastic Extinguisher, the conductor Tube (05), that drives out the fire extinguishing product, will have its inferior Base (07) practically of the same diameter of the Mouthpiece (02), being so larger than the superior outlet (06) besides containing the entrance Mouth (08) of diagonal cut, as well as the Mouthpiece (09) which funnel shape to propitiate a better aiming of the fire extinguishing product.

As expected, a plastic Extinguisher of such characteristics can be made to store different loads of fire extinguishing product as convenient to every commercial and residential building or industrial plant, among others.

1. “FIRE EXTINGUISHER WITH DISPOSABLE PLASTIC CONTAINER” of varied made to hold several different loads of fire extinguishing products to attend small family vehicles as well as all commercial, residential, industrial, nautical and naval, installations, working with direct pressure (internal), is characterized by a Container (01) manufactured with high viscosity Polyamide, Fiberglass and mineral elements composed by calcium, aluminum, magnesium, phosphorus, sodium, titanium, iron, potassium, zinc, strontium, copper, manganese and chrome, besides others for U.V protection, with a Wall (P) of thickness from three to twenty millimeters with a better results with five millimeters for the P1 model, in other words, fire extinguisher for small family vehicles.

2. “FIRE EXTINGUISHER WITH DISPOSABLE PLASTIC CONTAINER” according to claim 1 it is also characterized by the container (01) being of cylindrical shape on both extremities so that independently of the external Diameter (DE) and of the internal Diameter (DI) the extremities will have an 180° Angle (G) ray.

3. “FIRE EXTINGUISHER WITH DISPOSABLE PLASTIC CONTAINER” according to claim 1 the Container (01) is welded on the two extremities cut areas that are characterized by containing a small Rib (N) on the inferior and superior parts, formed by plastic concentration, with thickness from ten to a hundred percent of the Wall (P) being twenty percent the ideal.

4. “FIRE EXTINGUISHER WITH DISPOSABLE PLASTIC CONTAINER” according to claim 1 is also characterized by being a disposable fire extinguisher that doesn't allow the plastic Container be reutilized (01) once the external Threads (04) of the Valve (V) is welded to the internal Threads (03) of the Mouthpiece (02) through a process of molecular fusion by laser welding.

5. “FIRE EXTINGUISHER WITH DISPOSABLE PLASTIC CONTAINER” according to claim 1 is also characterized by a conductive Tube (05) for the fire extinguishing product where the inferior Base (07) will practically have the same diameter of the Mouthpiece (02), in other words, it will be larger than the superior outlet (06), as well as an entrance opening (08) cut in diagonal, besides containing an outlet Mouthpiece (09) of funnel shape.

6. “FIRE EXTINGUISHER WITH DISPOSABLE PLASTIC CONTAINER” according to claim 2 the Container (01) is welded on the two extremities cut areas that are characterized by containing a small Rib (N) on the inferior and superior parts, formed by plastic concentration, with thickness from ten to a hundred percent of the Wall (P) being twenty percent the ideal.

5. “FIRE EXTINGUISHER WITH DISPOSABLE PLASTIC CONTAINER” according to claim 4 is also characterized by a conductive Tube (05) for the fire extinguishing product where the inferior Base (07) will practically have the same diameter of the Mouthpiece (02), in other words, it will be larger than the superior outlet (06), as well as an entrance opening (08) cut in diagonal, besides containing an outlet Mouthpiece (09) of funnel shape.
